(19) United States
(12) Patent Application Publication
(10) Pub. No.: US 2014/0015825 A1
(43) Pub. Date: Jan. 16, 2014

(54) Method for Rendering a Layered Structure

(71) Applicant: Craig Steven Donner, Irvine, CA (US)

(72) Inventor: Craig Steven Donner, Irvine, CA (US)

(21) Appl. No.: 13/546,172

(22) Filed: Jul. 11, 2012

(51) Int. Cl. G06T 1/00; G06T 15/00

(52) U.S. Cl. 345/419; 345/418

(57) ABSTRACT

A computer-implemented method for rendering an image of an object, comprises: providing a set of surface points; providing the optical properties for the at least one layer; constructing an eigensystem using the optical properties of the at least one layer associated with each point in the set of surface points; extracting the eigenvalues and eigenvectors from the eigensystem at each point in the set of surface points; solving a system matrix using the extracted eigenvectors and eigenvalues and a continuous function of angular dependence to calculate reflectance values and transmittance values for the set of surface points; and rendering an image of the three dimensional object on a display using the reflectance values and the transmittance values calculated for the set of surface points.

### FIELD OF THE INVENTION

The invention relates to the field of computerized methods for rendering layered structures. The invention relates particularly to the rendering of skin and faces.

### BACKGROUND OF THE INVENTION

The outward appearance of layered structures may arise from the optical properties of the respective layers and the interfaces between the layers. Rendering methods wherein the appearance is a function of properties of the surface of the object may be insufficient to provide a rendered image having enough detail.

It is known to consider some optical properties of the inner layers of an object. Current computational methods limit the extent to which full calculations including all aspects of the optical properties of each point of each layer together with the respective interfaces between layers effect each point upon the surface of the object and overall outward appearance of the object.

What is desired is a more computationally efficient method of modeling and rendering complex layered structures including skin and therefore faces.

### SUMMARY OF THE INVENTION

In one aspect, a computer-implemented method for rendering an image of an object, comprises: providing a set of surface points; providing the optical properties for the at least one layer; constructing an eigensystem using the optical properties of the at least one layer associated with each point in the set of surface points; extracting the eigenvalues and eigenvectors from the eigensystem at each point in the set of surface points; solving a system matrix using the extracted eigenvectors and eigenvalues and a continuous function of angular dependence to calculate reflectance values and transmittance values for the set of surface points; and rendering an image of the three dimensional object on a display using the reflectance values and the transmittance values calculated for the set of surface points. The set of surface points represents a geometrical arrangement of a three dimensional object comprising at least one layer. In one aspect the object rendered may comprise a human face.

### DETAILED DESCRIPTION OF THE INVENTION

A computer-implemented method for rendering an image, comprising: providing a set of surface points representing a geometrical arrangement of an object; providing a thickness value for at least one surface layer of the object; using the thickness value to calculate a reflectance value and a transmittance value for each point in the set of surface points; and rendering an image of the object on a display using the reflectance values and the transmittance values calculated for the set of points; wherein calculating the reflectance and transmittance values comprises calculating the reflectance and transmittance values according to the integral of the Fresnel reflectance at the layer boundaries.

The set of surface points may be created as a representation of a three dimensional object. In one embodiment the set of points may represent a human face, or other biological structures. High definition scanning of an actual human face or other object may be used to generate the set of points and the corresponding geometrical arrangement and relationship of the points.

The thickness value may be provided as a thickness profile having a thickness value associated with each of the set of surface points and corresponding to a layer thickness at each point. The thickness profile may define a set of surface layers each layer of the set having a corresponding thickness at each point of the set. The thickness profile may be substantially uniform across the surface of the object or the thickness may have variation across the surface layer, or layers, of the object surface.

The total reflectance and transmittance of the layer may be found by first writing an expression for the transmitted radiance, that is, the radiance emitted out of the layer at the top and the bottom of the layer:

R_{d}=∫₋₁⁰Ψ₀(−μ)dμ=∫₋₁⁰Fₜ(−μ)Ψ₀(−μ)dμ, (1)

T_{d}=∫₀¹Ψ₁(μ)dμ=∫₀¹Fₜ(μ)Ψ₁(μ)dμ. (2)

In a plane parallel context, assuming rotational symmetry, and in a source-free medium (all incident light is external to the material), the reflectance transmittance equation may be expressed as:

$$μ \frac{\partial }{\partial z} ψ ( z , μ ) + {σ}_{t} ψ ( z , μ ) = {σ}_{s} {\int }_{- 1}^{1} p ( {μ}^{′} ) ψ ( z , {μ}^{′} ) d {μ}^{′} . \qquad ( 3 )$$

Operating on Equation (3) by ∫₋₁¹ Pₘ(μ)dμ gives:

$${\int }_{- 1}^{1} {P}_{m} ( μ ) μ \frac{\partial }{\partial z} ψ ( z , μ ) d μ + {σ}_{t} {\int }_{- 1}^{1} {P}_{m} ( μ ) ψ ( z , μ ) d μ = {σ}_{s} {\int }_{- 1}^{1} {P}_{m} ( {μ}^{′} ) {\int }_{- 1}^{1} {P}_{m} ( μ ) ψ ( z , {μ}^{′} ) d {μ}^{′} d μ$$

and substituting Legendre polynomials P_{N} for Ψ(z,μ) yields:

$${\sum }_{n = 0}^{N} \frac{2 n + 1}{2} \frac{\partial }{\partial z} {φ}_{n} ( z ) {\int }_{- 1}^{1} {P}_{m} ( μ ) μ {P}_{n} ( μ ) μ d μ + {σ}_{t} {\sum }_{n = 0}^{N} \frac{2 n + 1}{2} {φ}_{n} ( z ) {\int }_{- 1}^{1} {P}_{m} ( μ ) {P}_{n} ( μ ) d μ = {σ}_{s} {\int }_{- 1}^{1} {P}_{m} ( μ ) {\int }_{- 1}^{1} [ {\sum }_{n = 0}^{N} \frac{2 n + 1}{2} {g}^{n} {P}_{n} ( {μ}^{′} ) ] [ {\sum }_{n = 0}^{N} \frac{2 n + 1}{2} {φ}_{n} ( z ) {P}_{n} ( {μ}^{′} ) ] d {μ}^{′} d μ .$$

Using the Legendre identities gives the following system of equations:

$$\frac{m + 1}{2 m + 1} \frac{\partial }{\partial z} {φ}_{m + 1} ( z ) + \frac{m}{2 m + 1} \frac{\partial }{\partial t} {φ}_{m - 1} ( z ) + {σ}_{tm} {φ}_{m} ( z ) = 0 \qquad ( 4 )$$

where:

σₜₘ=σₐ+(1−g^{m})σₛ (5)

is the m-th moment of the Henyey-Greenstein phase function. Assuming a solution of the form:

φₙ(z)=\hat{φ}ₙe^{γz}, (6)

where z is a depth if interest, and substituting this into Equation (3) gives:

γ((m+1)\hat{φ}ₘ₊₁+m\hat{φ}ₘ₋₁)+(2m+1)σₜₘ\hat{φ}ₘ=0. (7)

This equation can be written in the following matrix form:

(γM+Σ)\hat{Φ}=0−M⁻¹Σ\hat{Φ}=γ\hat{Φ} (8)

where \hat{Φ} is a vector of all \hat{φ}, and M and Σ are:

$$\begin{matrix}{M}_{ij} = ( \begin{matrix}\frac{i}{2 i + 1} , & j = i - 1 \\ \frac{i + 1}{2 i + 1} , & j = i + 1 \\ 0 , & otherwise\end{matrix} \\ and & ( 9 ) \\ {\sum }_{ij} = ( \begin{matrix}{σ}_{ti} , & i = j \\ 0 , & otherwise .\end{matrix} & ( 10 )\end{matrix}$$

Equation (8) is a standard eigenvalue-eigenvector problem for the matrix M⁻¹Σ. Given the assumed solution in Equation (6) this problem has the general solution:

φ(z)=Σᵢ₌₁^{N/2}cᵢ\hat{φ}ᵢe^{γi(z-X)}+Σᵢ₌₁^{n/2}dᵢ\hat{φ}ᵢe^{γi(z-0)} (11)

where γᵢ and \hat{φ}ᵢ are the i-th eigenvalue and eigenvector pairs of M⁻¹Σ, cᵢ and dᵢ are constants that depend on the boundary conditions (described in the next sections), and X is the thickness of the plane-parallel slab. Equation (11) may be evaluated at any depth z, including at the interfaces of the slab where z=0 and z=X.

Boundary conditions:

For a slab with thickness X, the boundary conditions are that the inward directed radiance in direction pi is the sum of any external source function S and the internally reflected outward directed radiance:

Ψ₀(μ)=Fₜ(μ′)S₀(μ′)+Fᵣ (−μ)Ψ₀(−μ) (12)

Ψ₁(μ)=Fₜ(μ″)S₁(μ″)+Fᵣ(−μ)Ψ₁(−μ) (13)

where Fₜ(μ) is the Fresnel transmittance function 1−Fᵣ(μ), and the subscript indicates the interface: 0 is the top interface, and 1 is the bottom interface. S₀ is the radiance incident on the top interface, and S₁ is the radiance incident on the bottom interface, while μ′ and μ″ are the refracted versions of μ for each interface. By Snell's Law, if the ratios of refractive indices at the interfaces are η₀ and η₁, these angles are:

$${μ}^{′} = ( \begin{matrix}\sqrt{1 - {η}_{0}^{2} ( 1 - μ )} , & {η}_{0} \leq 1 \\ \sqrt{1 - \frac{1}{{η}_{0}^{2}} ( 1 - μ )} , & {η}_{0} \geq 1 ,\end{matrix} \\ {μ}^{″} = ( \begin{matrix}\sqrt{1 - {η}_{1}^{2} ( 1 - μ )} , & {η}_{1} \leq 1 \\ \sqrt{1 - \frac{1}{{η}_{1}^{2}} ( 1 - μ )} , & {η}_{1} \geq 1.\end{matrix} \qquad ( 14 )$$

Note that, since there are an infinite number of angles in the hemisphere, there are thus an infinite number of boundary conditions. To simplify the problem, the convention of Marshak, described in R. E. Marshak, Note on the spherical harmonic method as applied to the Milne problem for a sphere, in Physical Review 71(7), pages 443--446, 1947, is followed, and operate on these equations by ∫₀¹ Pₘ(μ)(·)dμ for the top conditions, and ∫₋₁⁰ Pₘ(μ)(·)dμ for the bottom conditions, where m is odd. This gives:

∫₀¹Ψ₀(μ)Pₘ(μ)dμ=∫₀¹Fₜ(μ′)S₀(μ′)Pₘ(μ)dμ+∫₀¹Fᵣ(−μ)Ψ₀(−μ)Pₘ(μ)dμ (15)

∫₋₁⁰Ψ₁(μ)Pₘ(μ)dμ=∫₋₁⁰Fₜ(μ″)S₁(μ″)Pₘ(μ)dμ+∫₋₁⁰Fᵣ(−μ)Ψ₁(−μ)Pₘ(μ)dμ (16)

Substitution of the Legendre polynomials into the top condition gives:

$${\sum }_{n = 0}^{N} \frac{2 n + 1}{4 π} {φ}_{n} {\int }_{0}^{1} {P}_{m} ( μ ) {P}_{n} ( μ ) d μ = {\int }_{0}^{1} {F}_{t} ( {μ}^{′} ) {S}_{0} ( {μ}^{′} ) {P}_{m} ( μ ) d μ + {\sum }_{n = 0}^{N} \frac{2 n + 1}{4 π} {φ}_{n} {\int }_{0}^{1} {F}_{r} ( - μ ) {P}_{m} ( μ ) {P}_{n} ( μ ) d μ \\ {\sum }_{n = 0}^{N} \frac{2 n + 1}{4 π} {φ}_{n} [ {\int }_{0}^{1} {P}_{m} ( μ ) {P}_{n} ( μ ) d μ - {\int }_{0}^{1} {F}_{r} ( - μ ) {P}_{m} ( μ ) {P}_{n} ( μ ) d μ ] = {\int }_{0}^{1} {F}_{t} ( {μ}^{′} ) {S}_{0} ( {μ}^{′} ) {P}_{m} ( μ ) d μ \qquad ( 17 )$$

Though the first term in brackets has a known solution, the second term, involving the integral of the Fresnel reflectance, does not. The integrals, and their difference, are smooth, however, and may be precomputed for a number of m, n combinations and stored in lookup tables, yielding:

$${\sum }_{n = 0}^{N} \frac{2 n + 1}{4 π} {Γ}_{0} ( m , n , 1 ) {φ}_{n} = {Φ}_{m} \qquad ( 18 )$$

where:

Γ₀(m, n, s)=∫₀¹Pₘ(μ′)Pₙ(s u′)dμ′−∫₀¹Fᵣ(μ′)Pₘ(μ′)Pₙ(sμ′)dμ′ (19)

is the precomputed difference of integrals (an analogous expression for Γ₁ exists using μ″), s is the sign of μ (positive for integration bounds from 0 to 1, and negative for bounds from −1 to 0), and:

Φₘ=∫₀¹Fₜ(μ′)S₀(μ′)Pₘ(μ)dμ (20)

is the integral of the source function with the Fresnel transmittance and Legendre polynomial. The expressions for the top and bottom interfaces differ only in the integration limits, and the use of μ′ or μ″.

Substituting the eigensystem solution from Equation (11) into Equation (18) gives:

$${\sum }_{n = 0}^{N} \frac{2 n + 1}{4 π} [ \begin{matrix}{Γ}_{0} ( m , n , 1 ) {\sum }_{i = 1}^{N / 2} {c}_{i} {\hat{φ}}_{i , n} {e}^{{γ}_{i} ( z - X )} + \\ {Γ}_{0} ( m , n , - 1 ) {\sum }_{i = 1}^{N / 2} {d}_{i} {\hat{φ}}_{i , n} {e}^{{γ}_{i} ( z - 0 )}\end{matrix} ] = {Φ}_{m} \qquad ( 21 )$$

where \hat{φ}_{i,n} is the n-th element of the i-th eigenvector. The order of summation may be altered to give:

$${\sum }_{i = 1}^{N / 2} {c}_{i} {e}^{{γ}_{i} ( z - X )} {\sum }_{n = 0}^{N} \frac{2 n + 1}{4 π} {Γ}_{0} ( m , n , μ ) {\hat{φ}}_{i , n} + {\sum }_{i = 1}^{N / 2} {d}_{i} {e}^{{γ}_{i} ( z - 0 )} {\sum }_{n = 0}^{N} \frac{2 n + 1}{4 π} {Γ}_{0} ( m , n , - μ ) {\hat{φ}}_{i , n} = {Φ}_{m} . \qquad ( 22 )$$

This is a system of equations, one for each value of m. The two interfaces of the slab have the same expression, with only the values of z (the depth of each interface) and the Γ integrals (due to mismatched refractive indices) differing:

$$\begin{matrix}{\sum }_{i = 1}^{N / 2} {c}_{i} {e}^{- {γ}_{i} X} {\sum }_{n = 0}^{N} \frac{2 n + 1}{4 π} {Γ}_{0} ( m , n , 1 ) {\hat{φ}}_{i , n} + {\sum }_{i = 1}^{N / 2} {d}_{i} {\sum }_{n = 0}^{N} \frac{2 n + 1}{4 π} {Γ}_{0} ( m , n , - 1 ) {\hat{φ}}_{i , n} = {Φ}_{m , t} , & ( 23 ) \\ {\sum }_{i = 1}^{N / 2} {c}_{i} {\sum }_{n = 0}^{N} \frac{2 n + 1}{4 π} {Γ}_{1} ( m , n , - 1 ) {\hat{φ}}_{i , n} + {\sum }_{i = 1}^{N / 2} {d}_{i} {e}^{- {γ}_{i} X} {\sum }_{n = 0}^{N} \frac{2 n + 1}{4 π} {Γ}_{1} ( m , n , 1 ) {\hat{φ}}_{i , n} = {Φ}_{m , b} . & ( 24 )\end{matrix}$$

This is a set of N equations (an equation for each interface for each m) with N unknowns (the cᵢ and dᵢ), which can be written in matrix-vector notation as:

$$\begin{matrix}( \begin{matrix}{R}_{{top}_{c}} & {R}_{{top}_{d}} \\ {R}_{{bot}_{c}} & {R}_{{bot}_{d}}\end{matrix} ) ( \begin{matrix}c \\ d\end{matrix} ) = ( \begin{matrix}{Φ}_{top} \\ {Φ}_{bot}\end{matrix} ) \\ where \text{:} & ( 25 ) \\ c = ( \begin{matrix}{c}_{1} \\ {c}_{2} \\ ⋮ \\ {c}_{N / 2}\end{matrix} ) , d = ( \begin{matrix}{d}_{1} \\ {d}_{2} \\ ⋮ \\ {d}_{N / 2}\end{matrix} ) , {Φ}_{top} = ( \begin{matrix}{Φ}_{1 , top} \\ {Φ}_{3 , top} \\ ⋮ \\ {Φ}_{N , top}\end{matrix} ) , {Φ}_{bot} = ( \begin{matrix}{Φ}_{1 , bot} \\ {Φ}_{3 , bot} \\ ⋮ \\ {Φ}_{N , bot}\end{matrix} ) & ( 26 )\end{matrix}$$

are vectors of length N/2 and the system matrix components are:

$$\begin{matrix}{R}_{{top}_{c} , i , j} = {e}^{- {γ}_{i} X} {\sum }_{n = 0}^{N} \frac{2 n + 1}{4 π} {Γ}_{0} ( 2 j - 1 , n , 1 ) {\hat{φ}}_{i , n} , & ( 27 ) \\ {R}_{{top}_{d} , i , j} = {\sum }_{n = 0}^{N} \frac{2 n + 1}{4 π} {Γ}_{0} ( 2 j - 1 , n , - 1 ) {\hat{φ}}_{i , n} , & ( 28 ) \\ {R}_{{bot}_{c} , i , j} = {\sum }_{n = 0}^{N} \frac{2 n + 1}{4 π} {Γ}_{1} ( 2 j - 1 , n , - 1 ) {\hat{φ}}_{i , n} , & ( 29 ) \\ {R}_{{bot}_{d} , i , j} = {e}^{- {γ}_{i} X} {\sum }_{n = 0}^{N} \frac{2 n + 1}{4 π} {Γ}_{1} ( 2 j - 1 , n , 1 ) {\hat{φ}}_{i , n} . & ( 30 )\end{matrix}$$

These matrices describe the internal reflection within the slab, defined by the boundary conditions.

Substitution of the Legendre polynomial approximation of the radiance into these gives:

$$\begin{matrix}{R}_{d} = {\sum }_{n = 0}^{N} \frac{2 n + 1}{4 π} {φ}_{0 , n} {\int }_{0}^{1} {F}_{t} ( μ ) d μ , & ( 31 ) \\ {T}_{d} = {\sum }_{n = 0}^{N} \frac{2 n + 1}{4 π} {φ}_{1 , n} {\int }_{0}^{1} {F}_{t} ( μ ) d μ , & ( 32 )\end{matrix}$$

and further substitution of the general solution to an eigenvector/eigenvalue problem for the matrix M⁻¹Σ gives:

$$\begin{matrix}{R}_{d} = {\sum }_{n = 0}^{N} \frac{2 n + 1}{4 π} [ {\sum }_{i = 1}^{N / 2} {c}_{i} {\hat{φ}}_{n , i} {e}^{- {γ}_{i} X} + {\sum }_{i = 1}^{N / 2} {d}_{i} {\hat{φ}}_{n , i} ] {\int }_{0}^{1} {F}_{t} ( μ ) d μ , & ( 33 ) \\ {T}_{d} = {\sum }_{n = 0}^{N} \frac{2 n + 1}{4 π} [ {\sum }_{i = 1}^{N / 2} {c}_{i} {\hat{φ}}_{n , i} + {\sum }_{i = 1}^{N / 2} {d}_{i} {\hat{φ}}_{n , i} {e}^{- {γ}_{i} X} ] {\int }_{0}^{1} {F}_{t} ( μ ) d μ . & ( 34 )\end{matrix}$$

The procedure to obtain the coefficient vectors c and d is as follows:
Build the layer-specific system matrices M and Σ as defined by:

(γM+Σ)(\hat{Φ}=0 −M⁻¹Σ\hat{Φ}=γ\hat{Φ} (8)

where \hat{Φ} is a vector of all \hat{φ}, and M and Σ are:

$$\begin{matrix}{M}_{ij} = ( \begin{matrix}\frac{i}{2 i + 1} , & j = i - 1 \\ \frac{i + 1}{2 i + 1} , & j = i + 1 \\ 0 , & otherwise\end{matrix} \\ and & ( 9 ) \\ {\sum }_{ij} = ( \begin{matrix}{σ}_{ti} , & i = j \\ 0 , & otherwise .\end{matrix} & ( 10 )\end{matrix}$$

Solve this linear system to obtain the eigenvalues γᵢ and eigenvectors \hat{φ}ᵢ.
Fill in the matrices (Equation 25) above using the eigenvalues and eigenvectors, as well as the precomputed Fresnel integrals, defined by Equations (18)-(20), with refracted angles defined in Equations (14).
Solve this linear system to obtain the coefficients cᵢ and dᵢ.

The precomputed Fresnel integrals may be referred to as PRECOMP1 or by any suitable call name and may be provided to the method from a look-up table or calculated in real time by the method.

The coefficients cᵢ and dᵢ may then be used in Equations (33) and (34) to calculate the total diffuse reflectance and transmittance of the layer. The integral of the Fresnel transmittance is quite smooth and can be approximated with a low-order polynomial, or precomputed and stored in a lookup table. Note that in the case of a single layer illuminated from above, all Φ_{m,bot} terms are zero. If the incident illumination at the top interfaces is collimated all (Φ_{m,t} terms are unity (less any surface reflection), and if the illumination is diffuse, (Φ_{m,t}=Γ₀(m, 0,1).

It is possible to solve for the total reflectance and transmittance an arbitrary system of plane-parallel layers.

The reflectance and transmittance for an arbitrary layer in a system of layers by replacing the source terms with the transmitted radiance from the adjacent layers:

∫₀¹Ψₗ(μ)Pₘ(μ)dμ=∫₀¹Fₜ(μ′)Ψₗ₋₁(μ′)Pₘ(μ)dμ+∫₀¹Fᵣ(−μ)Ψₗ(−μ)Pₘ(μ)dμ (35)

∫₋₁⁰Ψₗ₊₁(μ)Pₘ(μ)dμ=∫₋₁⁰Fₜ(μ″)Ψₗ(μ″)Pₘ(μ)dμ+∫₋₁⁰Fᵣ(−μ)Ψₗ₊₁(−μ)Pₘ(μ)dμ (36)

where l indicates the current layer, l−1 is the layer above l, and l+1 the layer below l. Using the same substitution procedure as before, the following is obtained for radiance at the top of an internal layer:

$${\sum }_{i = 1}^{N / 2} {c}_{l , i} {e}^{- {γ}_{l , i} {X}_{l}} {\sum }_{n = 0}^{N} \frac{2 n + 1}{4 π} {Γ}_{l} ( m , n , 1 ) {\hat{φ}}_{l , i , n} + {\sum }_{i = 1}^{N / 2} {d}_{l , i} {\sum }_{n = 0}^{N} \frac{2 n + 1}{4 π} {Γ}_{l} ( m , n - 1 ) {\hat{φ}}_{l , i , n} - {\sum }_{i = 1}^{N / 2} {c}_{l - 1 , i} {\sum }_{n = 0}^{N} \frac{2 n + 1}{4 π} {Λ}_{l} ( m , n , 1 ) {\hat{φ}}_{l - 1 , i , n} - {\sum }_{i = 1}^{N / 2} {d}_{l - 1 , i} {e}^{- {γ}_{l - 1 , i} {X}_{l - 1}} {\sum }_{n = 0}^{N} \frac{2 n + 1}{4 π} {Λ}_{l} ( m , n , - 1 ) {\hat{φ}}_{l - 1 , i , n} = 0 , \qquad ( 37 )$$

and for the radiance at the bottom of the internal layer:

$${\sum }_{i = 1}^{N / 2} {c}_{l , i} {\sum }_{n = 0}^{N} \frac{2 n + 1}{4 π} {Γ}_{l} ( m , n , - 1 ) {\hat{φ}}_{l , i , n} + {\sum }_{i = 1}^{N / 2} {d}_{l , i} {e}^{- {γ}_{l , i} {X}_{l}} {\sum }_{n = 0}^{N} \frac{2 n + 1}{4 π} {Γ}_{l} ( m , n , 1 ) {\hat{φ}}_{l , i , n} - {\sum }_{i = 1}^{N / 2} {c}_{l + 1 , i} {e}^{- {γ}_{l + 1 , i} {X}_{l + 1}} {\sum }_{n = 0}^{N} \frac{2 n + 1}{4 π} {Λ}_{1} ( m , n , - 1 ) {\hat{φ}}_{l , i , n} - {\sum }_{i = 1}^{N / 2} {d}_{i + 1 , i} {\sum }_{n = 0}^{N} \frac{2 n + 1}{4 π} {Λ}_{l} ( m , n , 1 ) {\hat{φ}}_{l , i , n} = 0 , \qquad ( 38 )$$

where:

Λₗ(m, n, s)=∫₀¹Fₜ(μ′)Pₘ(μ′)Pₙ(s u′)dμ′, (39)

are the integrals of the Fresnel transmittance and Legendre polynomials at the interface; like Γ, these integrals are easily precomputed or approximated with small polynomials. These coupled systems of equations may be expressed in matrix form. The topmost layer in a layered configuration is most similar to a single layer: the incident illumination may be described by the integrated source function. At the bottom of the top slab, there is an interface to another layer, indexed with “0,bot,” which may be non-zero, and there is also the upward transmitted radiance from the bottom layer incident on the second-to-last layer. Both are true of each inner layer. The equation for a three-layered system (which has four interfaces) may be expressed as:

$$( \begin{matrix}{R}_{0 , {top}_{c}} & {R}_{0 , {top}_{d}} & 0 & 0 & 0 & 0 \\ {R}_{0 , {bot}_{c}} & {R}_{0 , {bot}_{d}} & {T}_{1 , {top}_{c}} & {T}_{1 , {top}_{d}} & 0 & 0 \\ {T}_{0 , {bot}_{c}} & {T}_{0 , {bot}_{d}} & {R}_{1 , {top}_{c}} & {R}_{1 , {top}_{d}} & 0 & 0 \\ 0 & 0 & {R}_{1 , {bot}_{c}} & {R}_{1 , {bot}_{d}} & {T}_{2 , {top}_{c}} & {T}_{2 , {top}_{d}} \\ 0 & 0 & {T}_{1 , {bot}_{c}} & {T}_{1 , {bot}_{d}} & {R}_{2 , {top}_{c}} & {R}_{2 , {top}_{d}} \\ 0 & 0 & 0 & 0 & {R}_{2 , {bot}_{c}} & {R}_{2 , {bot}_{d}}\end{matrix} ) ( \begin{matrix}{c}_{0} \\ {d}_{0} \\ {c}_{1} \\ {d}_{1} \\ {c}_{2} \\ {d}_{2}\end{matrix} ) = ( \begin{matrix}{Φ}_{0 , t} \\ 0 \\ 0 \\ 0 \\ 0 \\ 0\end{matrix} ) \qquad ( 40 )$$

while the equation for a four-layered system (which has five interfaces) may be expressed as:

$$( \begin{matrix}{R}_{0 , {top}_{c}} & {R}_{0 , {top}_{d}} & 0 & 0 & 0 & 0 & 0 & 0 \\ {R}_{0 , {bot}_{c}} & {R}_{0 , {bot}_{d}} & {T}_{1 , {top}_{c}} & {T}_{1 , {top}_{d}} & 0 & 0 & 0 & 0 \\ {T}_{0 , {bot}_{c}} & {T}_{0 , {bot}_{d}} & {R}_{1 , {top}_{c}} & {R}_{1 , {top}_{d}} & 0 & 0 & 0 & 0 \\ 0 & 0 & {R}_{1 , {bot}_{c}} & {R}_{1 , {bot}_{d}} & {T}_{2 , {top}_{c}} & {T}_{2 , {top}_{d}} & 0 & 0 \\ 0 & 0 & {T}_{1 , {bot}_{c}} & {T}_{1 , {bot}_{d}} & {R}_{2 , {top}_{c}} & {R}_{2 , {top}_{d}} & 0 & 0 \\ 0 & 0 & 0 & 0 & {R}_{2 , {bot}_{c}} & {R}_{2 , {bot}_{d}} & {T}_{3 , {top}_{c}} & {T}_{3 , {top}_{d}} \\ 0 & 0 & 0 & 0 & {T}_{2 , {bot}_{c}} & {T}_{2 , {bot}_{d}} & {R}_{3 , {top}_{c}} & {R}_{3 , {top}_{d}} \\ 0 & 0 & 0 & 0 & 0 & 0 & {R}_{3 , {bot}_{c}} & {R}_{3 , {bot}_{d}}\end{matrix} ) ( \begin{matrix}{c}_{0} \\ {d}_{0} \\ {c}_{1} \\ {d}_{1} \\ {c}_{2} \\ {d}_{2} \\ {c}_{3} \\ {d}_{3}\end{matrix} ) = ( \begin{matrix}{Φ}_{0 , t} \\ 0 \\ 0 \\ 0 \\ 0 \\ 0 \\ 0 \\ 0\end{matrix} )$$

where the reflectance terms are as before:

$$\begin{matrix}{R}_{l , {top}_{c} , i , j} = {e}^{- {γ}_{l , i} {X}_{l}} {\sum }_{n = 0}^{N} \frac{2 n + 1}{4 π} {Γ}_{l} ( 2 j - 1 , n , 1 ) {\hat{φ}}_{l , i , n} , & ( 42 ) \\ {R}_{l , {top}_{d} , i , j} = {\sum }_{n = 0}^{N} \frac{2 n + 1}{4 π} {Γ}_{l} ( 2 j - 1 , n , - 1 ) {\hat{φ}}_{l , i , n} , & ( 43 ) \\ {R}_{l , {bot}_{c} , i , j} = {\sum }_{n = 0}^{N} \frac{2 n + 1}{4 π} {Γ}_{l + 1} ( 2 j - 1 , n , - 1 ) {\hat{φ}}_{l , i , n} , & ( 44 ) \\ {R}_{l , {top}_{d} , i , j} = {e}^{- {γ}_{l , i} {X}_{l}} {\sum }_{n = 0}^{N} \frac{2 n + 1}{4 π} {Γ}_{l + 1} ( 2 j - 1 , n , 1 ) {\hat{φ}}_{l , i , n} , & ( 45 )\end{matrix}$$

and the transmittance terms are defined from Equations (37) and (38):

$$\begin{matrix}{T}_{l , {top}_{c} , i , j} = - {\sum }_{n = 0}^{N} \frac{2 n + 1}{4 π} {Λ}_{l} ( 2 j - 1 , n , 1 ) {\hat{φ}}_{l - 1 , i , n} , & ( 46 ) \\ {T}_{l , {top}_{d} , i , j} = - {e}^{- {γ}_{l , i} {X}_{l}} {\sum }_{n = 0}^{N} \frac{2 n + 1}{4 π} {Λ}_{l} ( 2 j - 1 , n , - 1 ) {\hat{φ}}_{l - 1 , i ,} , & ( 47 ) \\ {T}_{l , {bot}_{c} , i , j} = - {e}^{- {γ}_{i} X} {\sum }_{n = 0}^{N} \frac{2 n + 1}{4 π} {Λ}_{l + 1} ( 2 j - 1 , n , - 1 ) {\hat{φ}}_{l + 1 , i , n} , & ( 48 ) \\ {T}_{l , {bot}_{d} , i , j} = - {\sum }_{n = 0}^{N} \frac{2 n + 1}{4 π} {Λ}_{l + 1} ( 2 j - 1 , n , - 1 ) {\hat{φ}}_{l + 1 , i , n } . & ( 49 )\end{matrix}$$

Solving equation (40) for the coefficient vectors allows the computation of the total reflectance and transmittance from any layer. In particular, plugging c₀ and d₀ into Equation (33) gives the total reflectance of the layered system, and plugging c_{N} and d_{N} into (34) give the total transmittance of the N-th (the bottom) layer.

The method may further include calculating reflectance and transmittance for an object having a layer of particles disposed upon its surface. Exemplary layers include cosmetics and other skin or surface treatment compositions. The composition may be characterized by providing a mean particle size and standard deviation for a plurality of particles of the layer.

In one embodiment, an actual face or a plurality of faces may be scanned and the chromophore data of the faces may be mapped. The mapped data may be provided as an input to the model. The data may be acquired under conditions of varying blood flow to the imaged area and under different spectral illumination.

The appearance of skin may depend upon the relative and absolute thicknesses of the respective layers as well as the distribution of compounds including melanin and keratin within the respective layers. The distribution of blood vessels as well as blood chemistry may also impact the appearance of the image of the skin. The scattering spectrum, thickness parameter map, refractive index spectra, baseline absorption spectrum, anisotropy spectrum of the stratum corneum may be provided as a distribution over the geometry of the object. The melanin distribution maps, thickness parameter maps, refractive index spectra, hemoglobin absorption spectra, hemoglobin parameter maps, etc. of the epidermis and/or dermis, and/or sub-dermis may be provided as inputs to the model for improving the rendering of a facial image.

The optical properties for a cosmetic layer such as: particle refractive index, absorption spectra, layer thickness map, particle volume fraction, particle radius distribution mean, particle radius distribution standard deviation may also be provided as inputs to the model.

The optical properties of a thin compositional layer embedded within the object may be included by calculating reflectance and transmittance values for the layer wherein the composition layer is modeled as comprising a plurality of particles.

The computed reflectance and transmittance profiles of individual layers may be convolved together to obtain layered-system profiles. The total reflectance and transmittance of each slab may be used to help stabilize the computation of the layer profiles, as well as the convolved profiles.

A sum-of-gaussians may provide a compact representation for a profile and has many desirable properties, such as fast separable convolution. A set of four gaussians well-describes those produced by a single pole of the dipole and multi-pole models, and leads to a set of simple functions to approximate a “pole.” This technique may be adopted to produce layer-specific profiles based on the reduced scattering coefficient σₛ′=(1−g)σₛ and reduced transport coefficient σₜᵣ=\sqrt{3σₐ(σₐ+σₛ′)}, calculated directly from the optical properties of each layer. Profiles generated using this method are based off of the diffusion approximation. They may be of similar shape, but differing in magnitude to the actual profile of the layer. The generated gaussian weights may be adjusted to ensure that the total diffuse reflectance and transmittance (the sum of the gaussian weights) matches the values predicted by the method. Using these corrected gaussian profiles, the profiles may be convolved together top-to-bottom as described in Eugene d'Eon, David Luebke, and Eric Enderton, Efficient rendering of human skin, in Rendering Techniques, pages 147--157, 2007, ensuring that the total reflectance and transmittance of the resulting profiles match those calculated using the method in Section 5. The result is a composite profile that has the correct total reflectance and transmittance. The convolving of the profiles may be accomplished according to the change in internal reflectance described by the Oren-Nayar model, the Torrance-Sparrow model, the Gaussian Cosine model, the Gaussian Sine model, the Gaussian Sum model, the Gaussian Sine Convolution model, or any other model of surface reflectance (such as a BRDF). The output of the model, a mapping of the reflectance and transmittance values for the points upon the surface of the object may be provided as an input to graphics display software and may be used to generate an image output to a display device. Exemplary image types include RGB images and other images types including both 2 dimensional and 3 dimensional images as are known in the art.

The method may be used to render an image of an object under different lighting conditions with regard to the spectral wavelengths incident upon the object, the intensity of the illumination and the location of the illumination source relative to the object.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A computer-implemented method for rendering an image, comprising:
a) providing a set of surface points representing a geometrical arrangement of an object;
b) providing a thickness value for at least one surface layer of the object;
c) using the thickness value to calculate reflectance values and a transmittances value for the set of surface points; and
c) rendering an image of the object on a display using the reflectance values and the transmittance values calculated for the set of points;
wherein step c) comprises calculating the reflectance and transmittance values according to the integral of the Fresnel reflectance at the layer boundaries.

2. The method according to claim 1 further comprising calculating reflectance and transmittance values for a thin, compositional layer on top of a thin object layer, wherein the compositional layer is modeled as comprising a plurality of particles.

3. The method according to claim 2 comprising the step of: providing a mean particle size for the plurality of particles of the compositional layer.

4. The method according to claim 1 further comprising a step of: convolving the reflectance and transmittance at the plurality of points.

5. The method according to claim 1 wherein the image is rendered as an image.

6. A computer-implemented method for rendering a facial image, comprising:
a) providing a set of surface points representing a geometrical arrangement of at least a portion of a human face;
b) providing a thickness value for a stratum cornenum skin layer;
c) providing the optical properties for the stratum corneum skin layer;
d) using the thickness value of the stratum corneum and the optical properties to calculate reflectance values and transmittance values for the stratum corneum skin layer represented by the set of surface points, wherein the reflectance values and the transmittance values are calculated according to the integral of the Fresnel reflectance at the layer boundaries; and
e) rendering a facial image on a display using the reflectance values and the transmittance values for the stratum corneum skin layer.

7. The method according to claim 6 further comprising a step of: collecting geometrical data from a human face to generate the plurality of surface points.

8. The method according to claim 6 further comprising a step of: collecting chromophore data from a human face for the plurality of points.

9. The method according to claim 6 further comprising a step of: providing the optical properties for the epidermis.

10. The method according to claim 6 further comprising a step of: providing the optical properties for the dermis.

11. The method according to claim 6 further comprising a step of: providing the optical properties for the sub-dermis.

12. The method according to claim 6 further comprising a step of: providing the optical properties for a cosmetic layer.

13. The method according to claim 6 further comprising a step of: convolving the reflectances and transmittances at the plurality of points.

14. The method according to claim 6 wherein the image is rendered as an image.

15. A computer-implemented method for rendering an image of an object, comprising:
a) providing a set of surface points representing a geometrical arrangement of a three dimensional object comprising at least one layer;
b) providing the optical properties for the at least one layer;
c) providing PRECOMP1 according to the Fresnel reflectance at the layer boundaries;
d) constructing an eigensystem using the optical properties of the at least one layer associated with each point in the set of surface points;
e) extracting the eigenvalues and eigenvectors from the eigensystem at each point in the set of surface points;
f) solving a system matrix using the extracted eigenvectors and eigenvalues and PRECOMP1 to calculate reflectance values and transmittance values for the set of surface points; and
g) rendering an image of the three dimensional object on a display using the reflectance values and the transmittance values calculated for the set of surface points.

16. The method according to claim 16 further comprising calculating reflectance and transmittance values for a thin, compositional layer on top of a thin object layer, wherein the compositional layer is modeled as comprising a plurality of particles.

17. The method according to claim 17 comprising the step of: providing a mean particle size and standard deviation for the plurality of particles of the compositional layer.

18. The method according to claim 16 further comprising a step of: convolving the reflectance and transmittance at the plurality of points.

19. The method according to claim 16 further comprising calculating reflectance and transmittance values for a thin, compositional layer embedded within an object wherein the composition layer is modeled as comprising a plurality of particles.

20. The method according to claim 16 wherein the image is rendered as an image.
